(19) United States
(12) Patent Application Publication
(10) Pub. No.: US 2012/0023539 A1
(43) Pub. Date: Jan. 26, 2012

(54) INFORMATION PROCESSING APPARATUS AND CONTENT RECEIVING METHOD

(75) Inventor: HIROKAZU NAGASHIMA, TOKYO (JP)

(73) Assignee: KABUSHIKI KAISHA TOSHIBA, TOKYO (JP)

(21) Appl. No.: 13/094,352

(22) Filed: Apr. 26, 2011

(30) Foreign Application Priority Data
Jul. 26, 2010 (JP) 2010-167486

(51) Int. Cl. H04N 7/173

(52) U.S. Cl. 725/116

(57) ABSTRACT

According to one embodiment, an information processing apparatus includes: an input module which receives an address of a content stored in a storage apparatus connected via a network; a managing module which stores the received address of the content and an identifier of the storage apparatus in such a manner that the address of the content and the identifier are correlated with each other; a receiving module configured to receive the identifier and an address of the storage apparatus from the storage apparatus after the input module received the address of the content; and an updating module which updates the address of the content which is correlated with an identifier that coincides with the identifier received by the receiving module among identifiers managed by the managing module, based on the address of the storage apparatus received by the receiving module.

### CROSS REFERENCE TO RELATED APPLICATION(S)

The application is based upon and claims the benefit of priority from Japanese Patent Application No. 2010-167486 filed on Jul. 26, 2010; the entire content of which are incorporated herein by reference.

### FIELD

Embodiments described herein relate generally to an information processing apparatus and a content receiving method.

### BACKGROUND

A technique for interconnecting, by a local area network, electronic apparatus such as a computer, a digital TV receiver, and a hard disk recorder that are provided in a home and allowing contents such as video and images to be shared by those electronic apparatus is known. For example, UPnP | is used as a mechanism for interconnecting such electronic apparatus and allowing them to operate. Using a UPnP protocol, a display apparatus such as a digital TV receiver can receive a content stored in a storage apparatus such as a recorder by sending a transmission request that specifies a URI of the content to the storage apparatus.

However, in a network, the IP address of an electronic apparatus connected to the network is subject to change. If the IP address of a storage apparatus is changed, the URI of each content stored in the storage apparatus is also changed. In this case, a display apparatus may not be able to receive a content from the storage apparatus.

### BRIEF DESCRIPTION OF THE DRAWINGS

FIG. 1 shows an example manner of use of a TV receiver according to an embodiment.

FIG. 2 shows example system configurations of the TV receiver and a computer according to the embodiment.

FIG. 3 shows an example data structure of a server information database stored in the TV receiver according to the embodiment.

FIG. 4 shows an example screen that is displayed by a computer according to the embodiment.

FIG. 5 shows an example data structure of a content information database stored in the TV receiver according to the embodiment.

FIG. 6 shows an example content information database generated updated by the TV receiver according to the embodiment.

FIGS. 7A and 7B show an example menu screen and a replay standby content selection screen, respectively, that are displayed by the TV receiver according to the embodiment.

FIG. 8 shows an example operation sequence of the TV receiver, the computer, and a server according to the embodiment.

FIG. 9 is a flowchart of an example process of generating a server information database which is executed by the TV receiver according to the embodiment.

FIG. 10 is a flowchart of an example process of sending a content URI which is executed by the computer according to the embodiment.

FIG. 11 is a flowchart of an example process of generating a content information database which is executed by the TV receiver according to the embodiment.

FIG. 12 is a flowchart of an example process of replaying a replay standby content which is executed by the TV receiver according to the embodiment.

### DETAILED DESCRIPTION

In general, according to one exemplary embodiment, an information processing apparatus is provided. The information processing apparatus includes: an input module which receives an address of a content stored in a storage apparatus connected via a network; a managing module which stores the received address of the content and an identifier of the storage apparatus in such a manner that the address of the content and the identifier are correlated with each other; a receiving module configured to receive the identifier and an address of the storage apparatus from the storage apparatus after the input module received the address of the content; and an updating module which updates the address of the content which is correlated with an identifier that coincides with the identifier received by the receiving module among identifiers managed by the managing module, based on the address of the storage apparatus received by the receiving module.

An embodiment of the present invention will be hereinafter described with reference to the drawings.

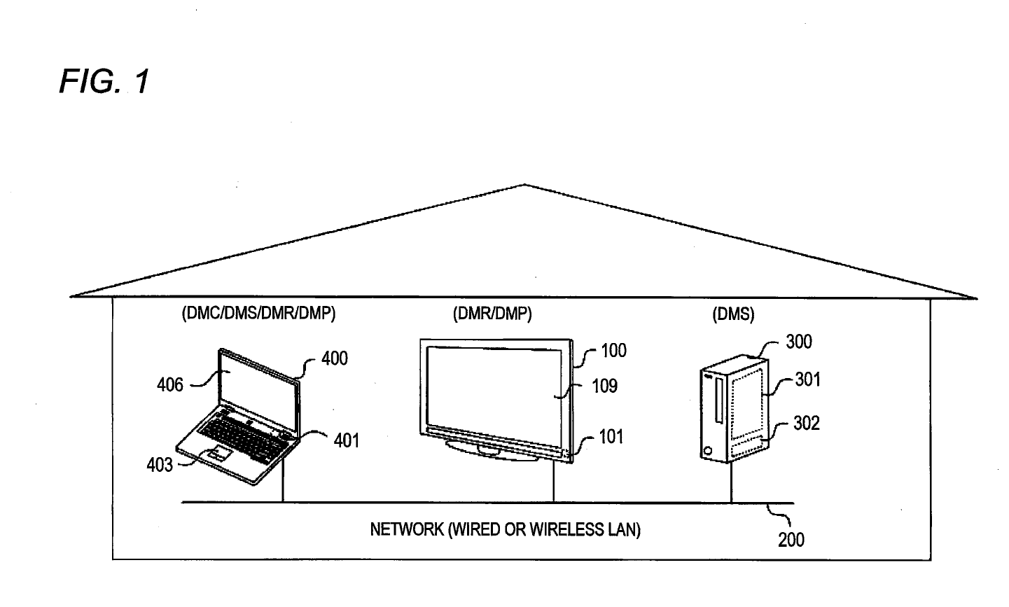

FIG. 1 shows an example configuration of a network system including a TV receiver 100 which is an information processing apparatus according to the embodiment. The TV receiver 100, a server 300, a computer 400, etc. are connected to a network 200 which is a wired or wireless LAN or the like.

Each of the TV receiver 100, the server 300, and the computer 400 has a UPnP function for controlling the function of each device on the network 200. UPnP will be described later.

The TV receiver 100 is provided with a communication module 101, a display unit 109, etc. The communication module 101 performs a communication with the server 300, the computer 400, etc. over the network 200. The display unit 109 is a display for displaying an image.

The TV receiver 100 receives a content from the server 300 by receiving a URI of the content from the computer 400 and sending a content transmission request that specifies a URI of the content to the server 300. The TV receiver 100 decodes (replays) the received content and displays video of the decoded content on the display unit 109.

The server 300 is a storage apparatus which is provided with a communication module 301, a storage unit 302, etc. The storage unit 302 is stored with contents of video, images, audio, etc. which are assigned respective URIs. When receiving a content transmission request which specifies a URI from the TV receiver 100 or the computer 400, the server 300 sends a content corresponding to the URI. The server 300 may be any storage apparatus capable of connection to the network 200 and may be a personal computer, an HDD recorder, or the like.

The computer 400 is provided with a communication module 401, an operation receiving unit 403, a display unit 406, etc. The computer 400 can receive, from the server 300, such pieces of information as a content name, a content length, and a URI of a content that are stored in the server 300. Furthermore, the computer 400 can give various instructions to the TV receiver 100. For example, the computer 400 causes the TV receiver 100 to receive and replay a content by sending a content URI setting instruction and a replay instruction to the TV receiver 100.

Each of the TV receiver 100, the server 300, and the computer 400 has a UPnP function for recognizing presence of each device on the network 200 and allowing the TV receiver 100 and the device on the network to control each other's function, and can function as, for example, a home network device prescribed by the Digital Living Network Alliance (DLNA) guidelines by using the UPnP function. In the guidelines, home network devices are classified into such categories as a digital media server (DMS), a digital media controller (DMC), a digital media renderer (DMR), and a digital media player (DMP).

DMC is a device for controlling such devices as DMS and DMR. DMS is a device which receives a content acquisition request (“HTTP get”) from DMR and supplies a corresponding content to DMR. DMS opens pieces of content information such as URIs and content names of respective contents stored in itself to a network using content director service (CDS) of UPnP so that each DMC can receive content information.

DMC can receive a URI of a content by receiving, by a browse action, for example, its content information that is opened by DMS using CDS. DMS causes DMR to set the received URI of the content (replay subject) therein by a “Set AV transport URI” action of audio/visual transport service (AVT) of UPnP that is provided in DMR.

If receiving a “play” action of AVT from DMC after the URI of the replay subject content has been set by DMC, DMR receives the content based on the received URI and replays the content. DMP has a function of searching for a content stored in DMS and replaying the content.

In the embodiment, the TV receiver 100 can functions as either of a DMP device and a DMR device. The server 300 can function as a DMS device, and the computer 400 can function as any of a DMC device, a DMP device, a DMS device, and a DMR device.

Incidentally, in related-art network systems, to cause DMR to replay image data stored in DMS, DMC instructs DMR to receive and replay a corresponding content and DMR immediately receives and replays the content according to the instruction.

On the other hand, in the network system according to the embodiment, when a URI of a replay subject content is set in DMR by an action from DMC, that is, when the TV receiver 100 receives the URI of the content from the computer 400, the TV receiver 100 can store the URI of the content.

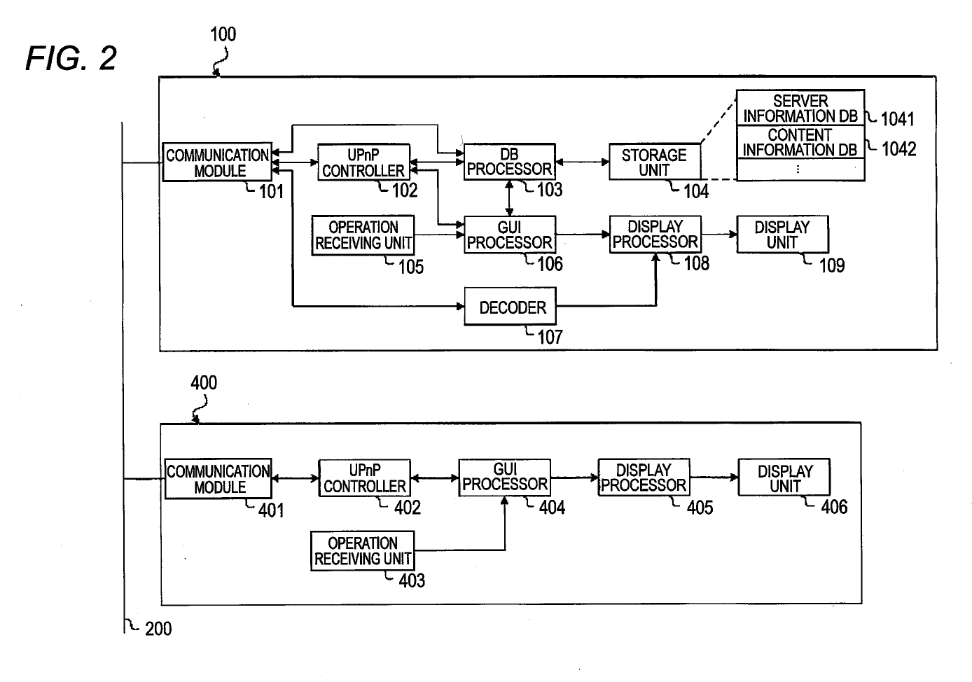

The TV receiver 100 according to the embodiment can receive and replay the content stored in the server 300 at a location indicated by the URI with arbitrary timing that is desired by the user. The details of this operation will be described later with reference to FIGS. 2 to 12.

Although FIG. 1 shows the server 300 and the computer 400 as devices which function as DMS devices, other DMS devices may be connected to the network 200. And DMR devices other than the TV receiver 100 and the computer 400 may be connected to the network 200.

Next, the TV receiver 100 and the computer 400 according to the embodiment will be described with reference to FIG. 2. FIG. 2 shows example system configurations of the TV receiver 100 and the computer 400.

First, the example system configuration of the TV receiver 100 will be described. The TV receiver 100 is provided with the communication module 101, a UPnP controller 102, a database processor 103, a storage unit 104, an operation receiving unit 105, a GUI processor 106, a decoder 107, a display processor 108, the display unit 109, etc.

The communication module 101 has a function of communicating with the server 300 and the computer 400 through the network 200.

The UPnP controller 102 has a function of sending and receiving UPnP commands etc. through the network 200. For example, the UPnP controller 102 sends a command that accords with a notice supplied from the database processor 103 or the GUI processor 106 and a command that accords with a setting in the UPnP controller 102 to the server 300 or the computer 400 from the communication module 101.

The UPnP controller 102 searches for UPnP devices connected to the network 200 by sending “M-search” to the network 200. When receiving a response containing an IP address of a server such as the server 300 from the server in response to the “M-search,” the UPnP controller 102 sends a server information transmission request to the server. A response containing server information that is sent in response to the server information transmission request is received by the communication module 101 and input to the database processor 103.

The term “server information” module is, for example, device-related information of a server which is called a device description (defined by UPnP) and stored in an extensible markup language (XML) file. The server information contains a unique device name (UDN) which is an identifier unique to a server, a device name of the server, a friendly name which is set arbitrarily for the server by a user, etc.

When receiving a notice called “ssdp:alive” from the server 300 or the like, the UPnP controller 102 sends a server information transmission request to the server 300 or the like that sent the notice. The notice “ssdp:alive” is to inform other devices on a network that a UPnP device has been connected to the network when the UPnP device has been connected to the network.

The UPnP controller 102 may send a server information transmission request when receiving an instruction from the database processor 103.

The UPnP controller 102 receives a content URI setting instruction, a content replay instruction, etc. from the computer 400. The content URI setting instruction is an instruction to set a URI of a content in the TV receiver 100, and is sent from the computer 400 as a “Set AV Transport URI” command of AVT of UPnP. The content URI setting instruction contains a URI, a content name, etc. of the content.

When receiving a content URI setting instruction, the UPnP controller 102 outputs the content URI setting instruction to the database processor 103. If receiving a replay instruction after receiving a content URI setting instruction, the UPnP controller 102 sends a content transmission request “HTTP get” that is directed to a location indicated by a URI that is contained in the content URI setting instruction.

When receiving a URI of a content from the GUI processor 106, the UPnP controller 102 sends “HTTP get” which designates the URI.

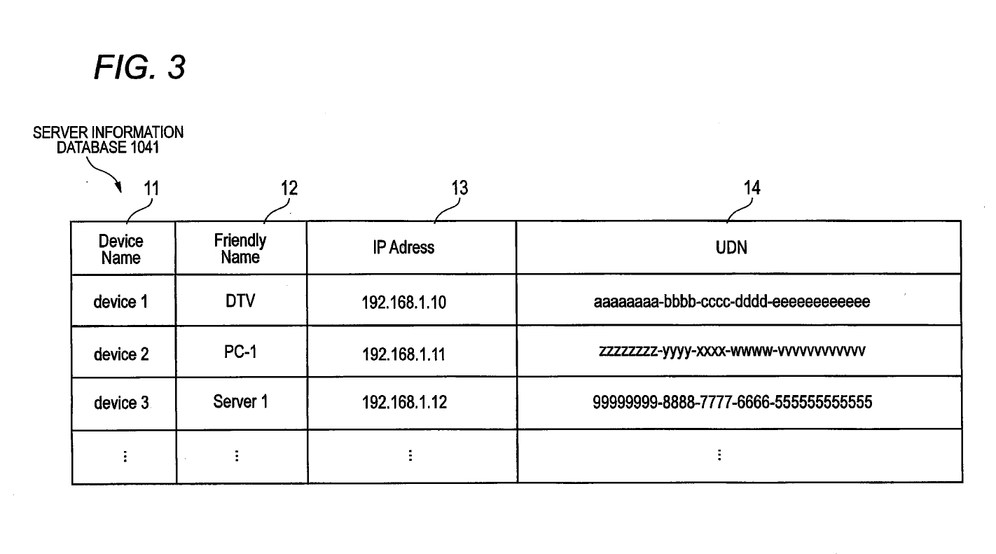

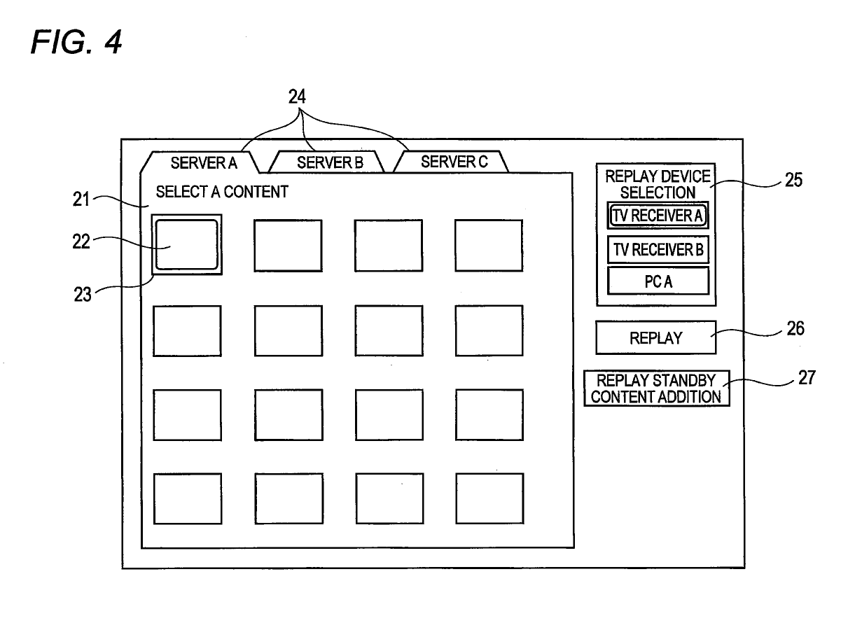

The database processor 103 has a function of generating or updating a database based on server information that is input from the communication module 101 or information contained in a content URI setting instruction that is input from the UPnP controller 102 and storing a resulting database in the storage unit 104. The database processor 103 generates a server information database 1041 based on server information that is input from the communication module 101 and generates a content information database 1042 based on information contained in a content URI setting instruction that is input from the UPnP controller 102. The databases 1041 and 1042 will be described later with reference to FIGS. 3 and 4.

The database processor 103 has a function of outputting the content information database 1042 stored in and managed by the storage unit 104 to the GUI processor 106 in response to an instruction supplied from the GUI processor 106 and a function of updating the content information database 1042 according to a replay content notice supplied from the GUI processor 106 and outputting an updated content information database 1042 to the GUI processor 106.

The operation receiving unit 105 receives an operation that is input through an input device such as a remote controller (not shown). The operation receiving unit 105 receives an operation for displaying a menu screen, an operation for causing a screen transition, an operation for selecting or deciding on a content, etc. and outputs instructions that accord with the respective operations to the GUI processor 106.

The GUI processor 106 has a function of generating a replay standby content selection screen through which to select a content to be replayed from contents corresponding to a URI setting instruction received by the TV receiver 100 and a menu screen for causing a transition to the replay standby content selection screen and a function of processing an operation on these screens.

When receiving an instruction to display the menu screen from the operation receiving unit 105, the GUI processor 106 generates the menu screen and outputs it to the display processor 108. If receiving an instruction to make a transition to the replay standby content selection screen from the operation receiving unit 105 while the TV receiver 100 is displaying the menu screen, the GUI processor 106 generates and outputs the replay standby content selection screen.

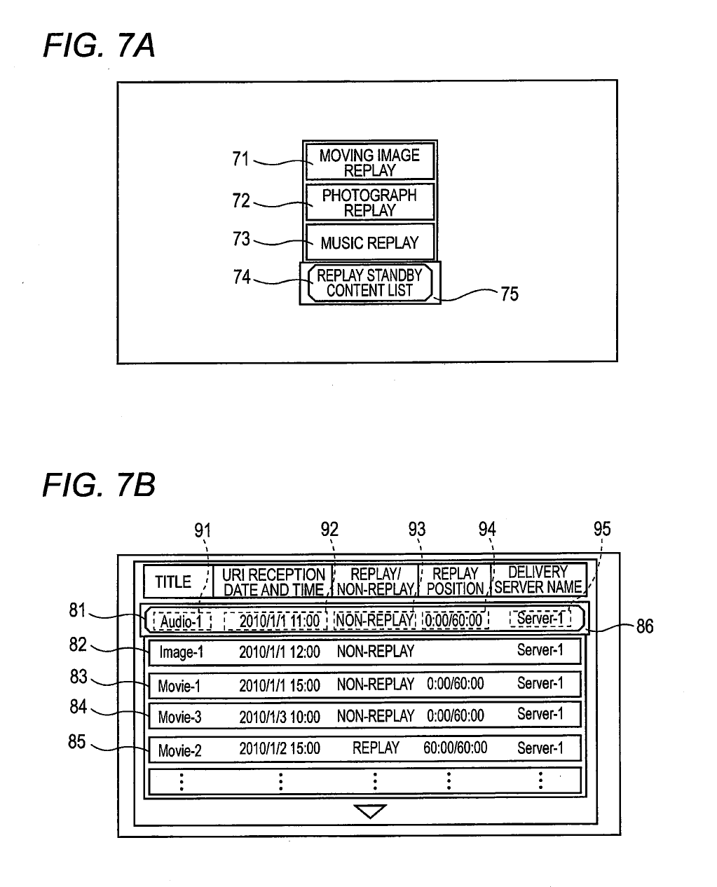

In generating the replay standby content selection screen, the GUI processor 106 requests the database processor 103 to supply the content information database 1042. The GUI processor 106 generates the replay standby content selection screen based on the content information database 1042 that is input from the database processor 103. The details of the menu screen and the replay standby content selection screen which are generated by the GUI processor 106 will be described later with reference to FIG. 7.

If receiving, from the operation receiving unit 105, an instruction to select and decide on a content shown in the replay standby content selection screen while the TV receiver 100 is displaying the replay standby content selection screen, the GUI processor 106 outputs, to the database processor 103, a replay content notice relating to a selected and decided-on content.

When receiving, from the database processor 103, a content information database 1042 as updated according to the replay content notice, the GUI processor 106 sends, via the UPnP controller 102, a content transmission request that is directed to a location indicated by a URI that is determined based on the content information database 1042 and the content selection and decision instruction supplied from the operation receiving unit 105.

The decoder 107 has a function of decoding a content that is input from the communication module 101 and outputting a decoded content to the display processor 108 and an audio processor (not shown). A content that is transmitted from the server 300 in response to a content transmission request (“HTTP get”) transmitted from the UPnP controller 102 is input to the decoder 107. The decoder 107 decodes (replays) the received content and a resulting content to the display processor 108. More specifically, the decoder 107 outputs image (video) data and audio data of the decoded content to the display processor 108 and the audio processor, respectively.

The display processor 108 converts the image data that are input from the GUI processor 106 and the decoder 107 into a video signal and outputs the video signal to the display unit 109. The display unit 109 displays an image based on the video signal that is input from the display processor 108.

Next, the example configuration of the computer 400 will be described. The computer 400 is provided with the communication module 401, a UPnP controller 402, the operation receiving module 403, a GUI processor 404, a display processor 405, the display unit 406, etc.

The communication module 401 has a function of communicating with the TV receiver 100 and the server 300 through the network 200.

The UPnP controller 402 has a function of sending and receiving UPnP commands through the network 200. For example, the UPnP controller 402 sends, from the communication module 401, a content URI setting instruction or a content replay instruction to the TV receiver 100 according to a notice supplied from the GUI processor 404.

The content URI setting instruction is an instruction to cause the TV receiver 100 to set a URI of a replay subject content therein, and is sent as a “Set AV Transport URI” command of AVT of UPnP, for example. The content URI setting instruction contains such information as a URI and a content name of a content.

The GUI processor 404 has a function of generating and outputting various screens and a function of processing operations that are input through those screens. More specifically, when the computer 400 sends a URI of a content to another device, the GUI processor 404 generates a URI setting content selection screen for making a selection and a decision as to a URI of what content should be sent.

When receiving an operation on the URI setting content selection screen from the operation receiving unit 403, the GUI processor 404 performs processing that accords with the operation. The URI setting content selection screen and processing to be performed according to an operation on the URI setting content selection screen will be described later with reference to FIG. 4.

The display processor 405 converts data of a screen such as the URI setting content selection screen which is input from the GUI processor 404 into a video signal and outputs the latter to the display unit 406. The display unit 406 displays video based on the video signal that is input from the display processor 405.

Next, the server information database 1041 which is generated and managed by the database processor 103 will be described with reference to FIG. 3. FIG. 3 shows an example data structure of the server information database 1041.

When receiving, from a server such as the server 300 connected to the network 200, an IP address and server information of the server, the database processor 103 generates a server information database 1041 based on the IP address and a UDN, a device name, a friendly name, etc. that are contained in the server information.

A device name 11, a friendly name 12, an IP address 13, and a UDN 14 are held in the server information database 1041 so as to be correlated with each other for each device. The device name 11 is a device name (identifier) that is set uniquely for each device by the TV receiver 100, and may be an index or the like for identification of each device in the server information database 1041. The friendly name 12 is, for example, a device name that is set arbitrarily by the user. The IP address 13 is an address of each device on the network 200. The UDN 14 is a unique identifier that is owned by and indicates each device.

Incidentally, the IP address of a device that is connected to the network 200 may be changed by, for example, power-on/off of the device. And the friendly name can also be changed arbitrarily by the user. Therefore, the TV receiver 100 receives pieces of server information from the servers connected to the network 200 by sending server information transmission requests to the servers every predetermined time, for example, and updates the server information database 1041 every time the TV receiver 100 receives server information.

Next, an example structure of the URI setting content selection screen which is displayed by the computer 400 will be described with reference to FIG. 4. The example URI setting content selection screen shown in FIG. 4 includes a content selection column 21, contents 22, a cursor 23, server selection tabs 24, a replaying device selection column 25, a replay button 26, a replay standby content addition button 27, etc.

The content selection column 21 is a column for displaying information of a content to be selected, and the contents 22, the cursor, etc. are shown in the content selection column 21. Each of the contents 22 is an image etc. as information of a content and is, for example, a title and a thumbnail of the content. The cursor 23 is an image for selecting a content.

The server selection tabs 24 are images for making a selection and a decision as to the contents stored in and opened by what server should be shown in the content selection column 21. The contents stored in plural servers may be shown in the content selection column 21.

The replaying device selection column 25 is a column for selecting a device for displaying a content selected in the content selection column 21. Devices that are connected to the computer 400 via the network 200 and can replay the content are shown in the replaying device selection column 25.

The replay button 26 is a button for causing a device selected in the replaying device selection column 25 to replay the content selected in the content selection column 21. When receiving an operation on the replay button 26, the computer 400 sends a content URI setting instruction containing the URI, the content name, etc. of the content selected in the content selection column 21 to the device selected in the replaying device selection column 25 and also sends a replay instruction to that device. That is, the computer 400 instructs the device selected in the replaying device selection column 25 to replay the selected content by sending a “Set AV Transport URI” command of AVT of UPnP and a “play” command, for example, to the selected device.

The replay standby content addition button 27 is a button for sending a content URI setting instruction containing the URI and the content name of the content selected in the content selection column 21 to the device selected in the replaying device selection column 25. When receiving an operation on the replay standby content addition button 27, the computer 400 sends the URI and the content name of the content selected in the content selection column 21 to the device selected in the replaying device selection column 25 using, for example, “Set AV Transport URI” etc. of AVT of UPnP.

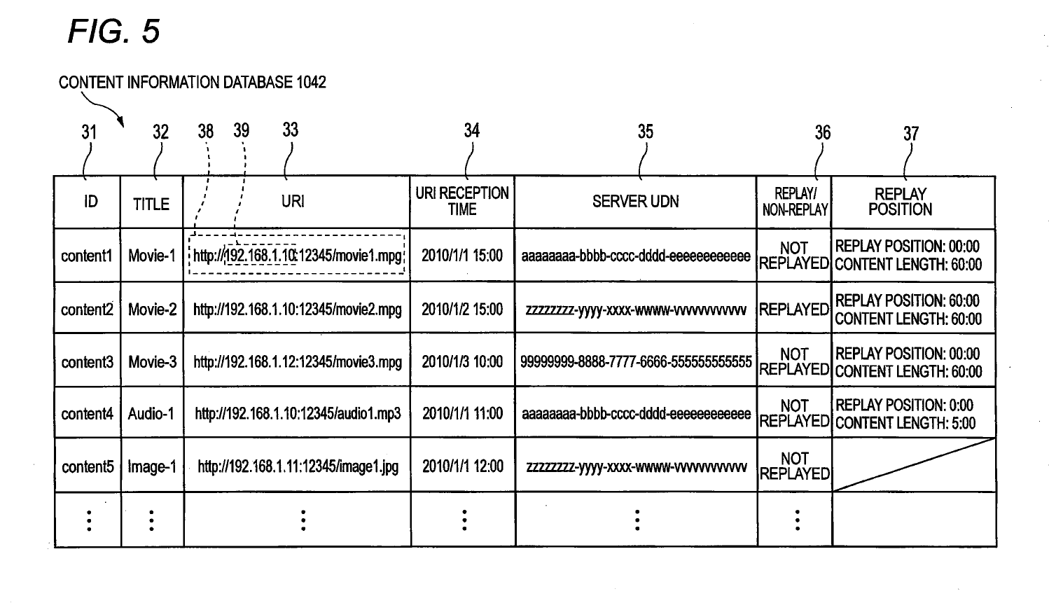

Next, the content information database 1042 which is generated and managed by the database processor 103 will be described. FIG. 5 shows an example data structure of the content information database 1042.

An ID 31, a title 32, a URI 33, a URI reception time 34, a server UDN 35, replay/non-replay information 36, and a replay position 37 are held in the content information database 1042 so as to be correlated with each other for each content.

The ID 31 is a content identifier which is given by the TV receiver 100 when, for example, the TV receiver 100 receives a content URI setting instruction from the computer 400, that is, when the TV receiver 100 receives a URI of a content. The title 32 is a title of a content. The URI 33 is information indicating an address where a content is stored and opened. The title and the address are contained in a content URI setting instruction that is sent from the computer 400. The URI reception time 34 is a date and time when the TV receiver 100 received a URI.

The server UDN 35 is a UDN of a server where a content is stored. The server UDN 35 is stored based on the server information database 1041. An IP address and a UDN of each server are correlated with each other in the server information database 1041. On the other hand, for example, a content URI 38 includes an IP address 39 of a server where the content is stored.

Therefore, the database processor 403 can correlate a URI of a content and a UDN of a server where the content is stored based on an IP address of the server contained in a content URI that is contained in a received content URI setting instruction and the server information database 1041 in which the IP address and the UDN of the server are held so as to be correlated with each other.

The replay/non-replay information 36 is information indicating whether or not the TV receiver 100 has replayed a content. The database processor 403 may change the replay/non-replay information 36 to “replayed” when the TV receiver 100 has completed replay of a content, that is, the TV receiver 100 has replayed a content to its end. Alternatively, the database processor 403 may change the replay/non-replay information 36 to “replayed” when the TV receiver 100 has replayed even part of a content.

The replay position 37 is information indicating a content length of is a content and a position in the content length to which the content has been replayed. The content length need not always be represented by a time and may be represented in bytes, for example. For example, the replay position is received in such a manner that the data processor 103 receives, from the decoder 107, information indicating a decoding position of the decoder 107. Alternatively, the replay position can be received from the UPnP controller 102 by the database processor 103 after the computer 400 sent a “seek” request of AVT of UPnP to the TV receiver 100.

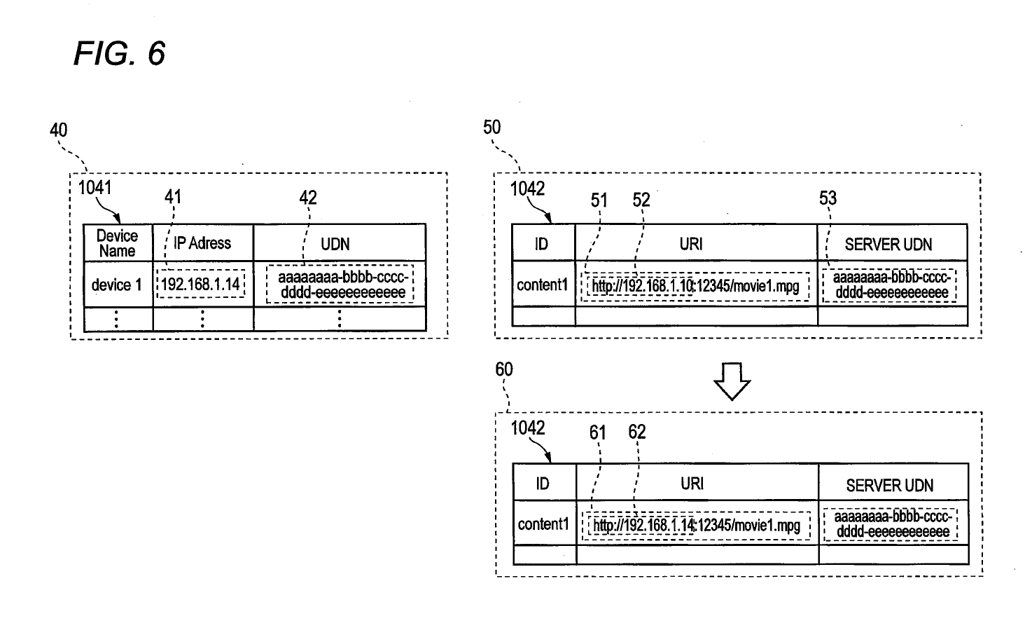

Next, an example operation that the database processor 103 updates a content URI of the content information database 1042 will be described with reference to FIG. 6. In FIG. 6 reference numerals 40 and 50 denote the server information database 1041 and the content information database 1042 at a certain time point, respectively. In FIG. 6, parts of the server information database 1041 and the content information database 1042 are omitted (see FIGS. 3 and 5).

An IP address 41 and a UDN 42 are held in the server information database 1041 (reference numeral 40) so as to be correlated with each other. The server information database 1041 is updated based on pieces of server information that are received from the server 300 etc. every predetermined time, for example, by the database processor 103.

A URI 51 of a content and a UDN 53 of a server that is stored with the content are held in the content information database 1042 (reference numeral 50) so as to be correlated with each other. The URI 51 of the content contains an IP address of a server that is stored with the content. However, the IP address 52 does not necessarily coincide with a latest IP address of the server.

Therefore, the database processor 103 searches the server information database 1041 for a UDN that coincides with the UDN 53 that is correlated with the IP address 52. If the server information database 1041 holds a UDN that coincides with the UDN 53, the database processor 103 determines whether or not the IP address that is correlated with that UDN in the server information database 1041 coincides with the IP address 52.

Since the UDN 53 in the content information database 1042 coincides with the UDN 42 in the server information database 1041 of FIG. 6, the database processor 103 determines whether or not the IP address 41 that is correlated with that UDN 42 coincides with the IP address 52. If the IP address 41 does not coincide with the IP address 52, the database processor 103 updates the IP address 52 and the URI 51 held in the content information database 1042 based on the IP address 41 held in the server information database 1041.

Reference numeral 60 denotes an updated content information database 1042, which holds a URI 61 that has been updated using the server IP address 41 held in the server information database 1041. The URI 61 includes the IP address 62 of the server that is stored with the content concerned.

Next, an example screen that is generated by the GUI generating module 106 will be described with reference to FIGS. 7A and 7B. FIG. 7A shows an example menu screen in which a moving image replay button 71, a photograph replay button 72, a music replay button 73, a replay standby content list button 74, etc. are shown as selectable buttons and a cursor 75 for selecting and deciding on one of the buttons 71 to 74 is also shown.

The TV receiver 100 can select and decide on one of the buttons 71 to 74 by moving the cursor 75 according to an operation received by the operation receiving unit 105. If the moving image replay button 71, for example, is selected and decided on, the GUI generating module 106 displays a list of moving image contents that are stored in the servers connected to the network 200. Likewise, the GUI generating module 106 displays a list of still image contents if the photograph replay button 72 is selected and decided on, and displays a list of musical contents if the music replay button 73 is selected and decided on.

If the replay standby content list button 74 is selected, a transition is made to a screen shown in FIG. 7B. FIG. 7B shows an example replay standby content selection screen that is generated by the TV receiver 100 based on the server information database 1041 and the content information database 1042 which were described above with reference to FIGS. 3 and 5. Replay standby contents are shown in the replay standby content selection screen.

Content selection buttons 81-85 and a cursor 86 are shown in the replay standby content selection screen of FIG. 7B. A title 91, a URI reception date and time 92, replay/non-replay information 93, a replay position 94, and a delivery server name 95 of a content are shown in each of the content selection buttons 81 to 85.

The content selection buttons 81-85 are buttons for selecting a content to be replayed. The content selection buttons 81 to 85 are shown (arranged) in ascending or descending order of dates and times when the TV receiver 100 received URIs of contents corresponding to the respective buttons 81 to 85.

In the replay standby content selection screen of FIG. 7B, among the content selection buttons 81 to 85, buttons corresponding to non-replayed contents are displayed preferentially by the TV receiver 100. That is, the TV receiver 100 displays the buttons 81-84 corresponding to non-replayed contents in URI reception time order and displays the button 85 corresponding to a replayed content under the buttons 81-84.

Like the button 85, the TV receiver 100 may display buttons corresponding to replayed contents (replayed by the TV receiver 100) in a different color than buttons corresponding to non-replayed contents. Alternatively, the TV receiver 100 may refrain from displaying buttons corresponding to replayed contents in the replay standby content selection screen.

The cursor 86 is an image for selecting and deciding on one of the content selection buttons 81 to 85 and causing the TV receiver 100 to replay a content corresponding to the selected and decided-on button. The TV receiver 100 can select and decide on one of the content selection buttons 81 to 85 by moving the cursor 86 according to an operation received by the operation receiving unit 105.

The title 91 is a title of a content. The URI reception date and time 92 is information indicating a date and time when a content URI was received by the TV receiver 100. The replay/non-replay information 93 is information indicating whether or not a content has been replayed. The replay position is information indicating to what position in the content length a content has been replayed. The delivery server name 95 is information indicating a friendly name or the like of a server in which a content is stored. A thumbnail of a content, a file type of a content, or the like may be shown in each of the content selection buttons 81 to 85.

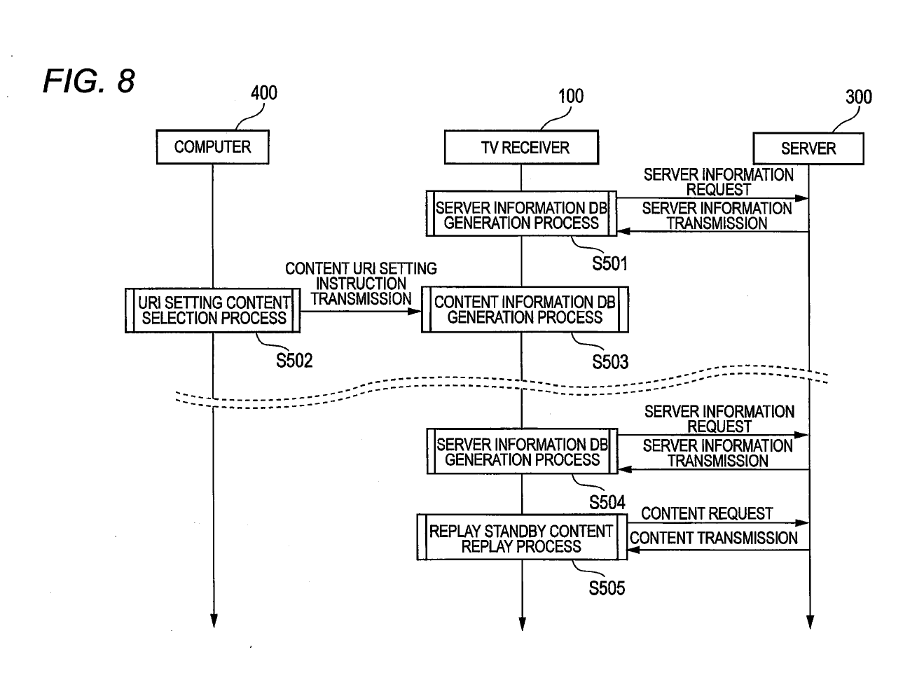

Next, an example operation sequence of the TV receiver 100, the server 300, and the computer 400 according to the embodiment will be described with reference to FIG. 8.

In this sequence, first, at step S501, the TV receiver 100 executes a server information database generation process. In the server information database generation process, the TV receiver 100 receives, from the server 300, an IP address of the server 300 and server information including a UDN etc. of the server 300, and generates a server information database 1041 based on the received IP address and server information.

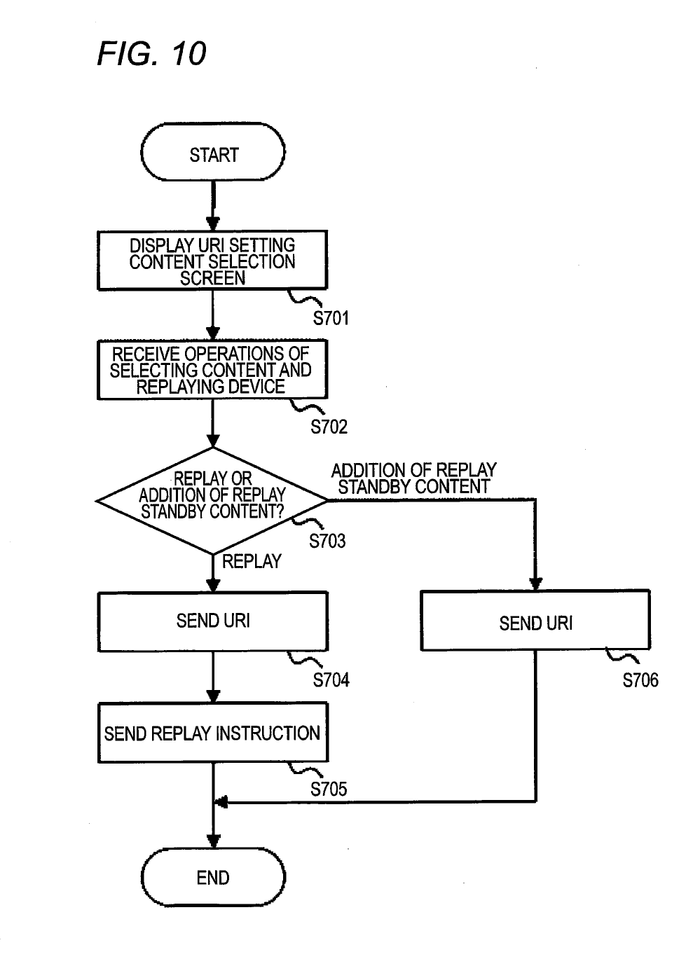

At step S502, the computer 400 displays a URI setting content selection screen as shown in FIG. 4 and performs a URI setting content selection process of receiving an operation on the URI setting content selection screen. The URI setting content selection process will be described later with reference to FIG. 10.

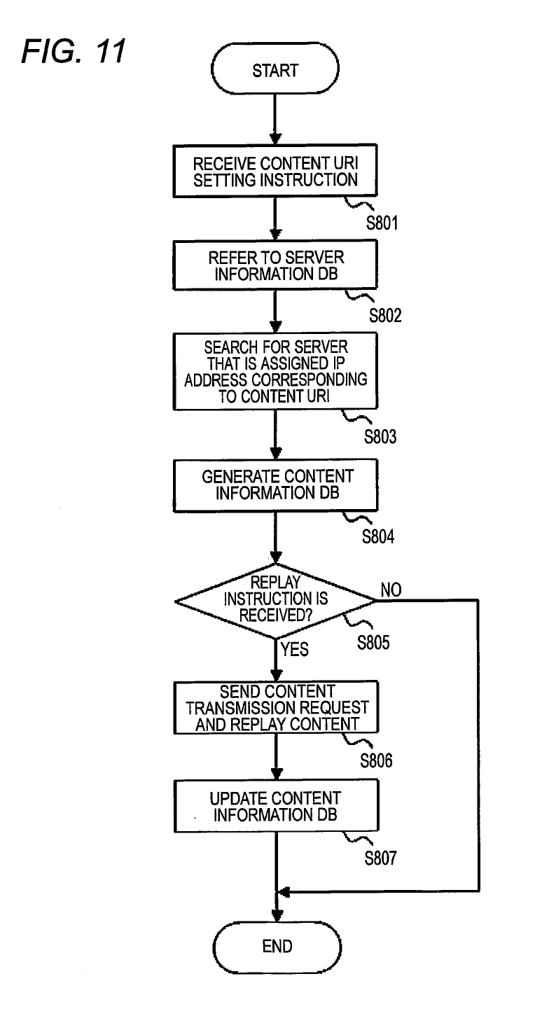

When receiving a content URI from the computer 400, at step S503 the TV receiver 100 executes a processing of generating a content information database 1042 based on the received URI. The details of this processing will be described later with reference to FIG. 11.

After receiving the content URI from the computer 400 at step S503, at step S504 the TV receiver 100 regularly executes a processing of generating (updating) a server information database 1041 and thereby receives a latest IP address of the server 300 that is stored with contents.

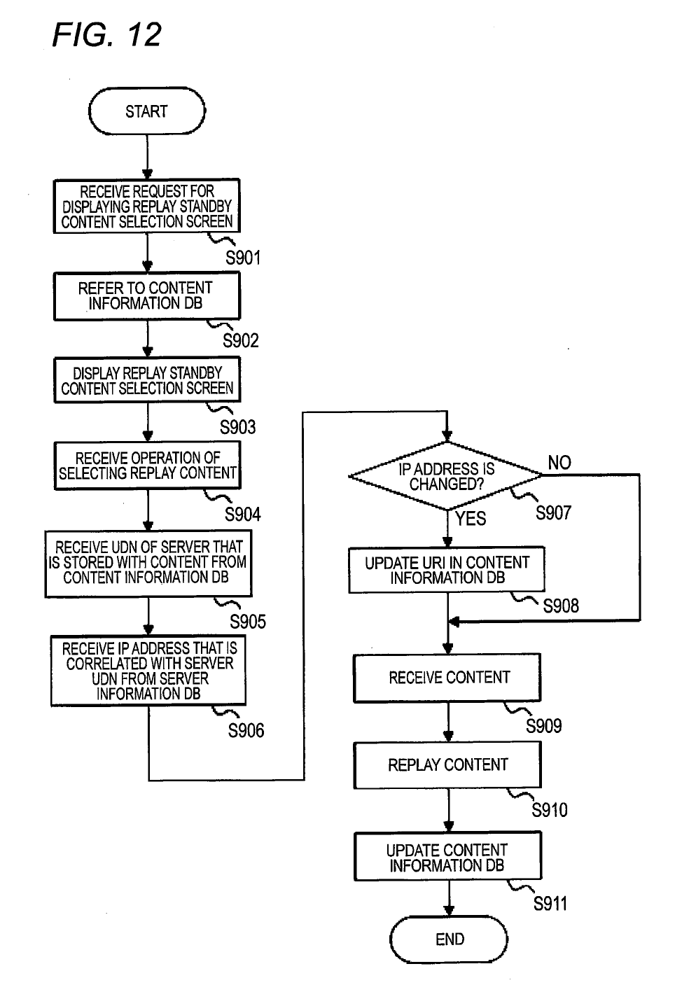

When receiving a replay standby content selection screen display request and a content selection operation on a replay standby content selection screen, at step S505 the TV receiver 100 executes a content replay processing. The details of this processing will be described later with reference to FIG. 12.

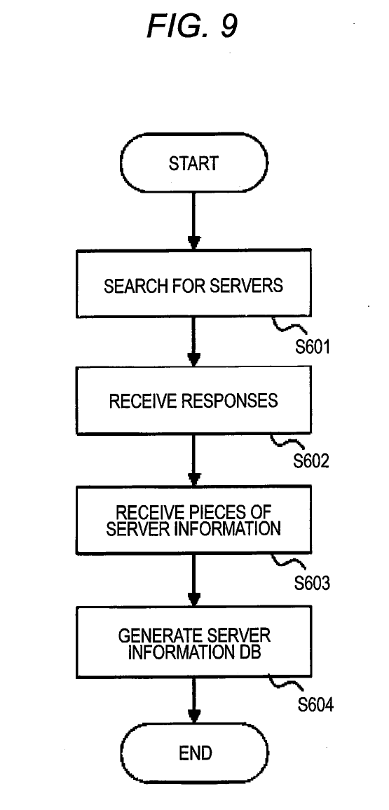

Next, an example processing of generating a server information database 1041 which is executed by the TV receiver 100 will be described with reference to a flowchart of FIG. 9.

First, at step S601, the TV receiver 100 searches for devices connected to the network 200 by sending search signals such as “M-search” of UPnP to the entire network 200. At step S602, the TV receiver 100 receive, from servers such as the server 300 connected to the network 200, responses (containing IP addresses of the servers, respectively) to the search signals. At step S603, the TV receiver 100 receives pieces of server information from the servers from which the responses have been received by sending “HTTP get,” for example, to the servers.

At step S604, the TV receiver 100 generates a server information database 1041 based on the received pieces of server information and the IP addresses of the servers. If a server information database 1041 already exists, at step S604 the TV receiver 100 updates the existed server information database 1041 based on the pieces of server information received at step S603. This processing can be executed every predetermined time. A server information database 1041 can be generated or updated by executing this processing every 10 seconds, for example.

Next, an example URI setting content selection processing which is executed by the computer 400 will be described with reference to a flowchart FIG. 10.

First, at step S701, the computer 400 displays a URI setting content selection screen as shown in FIG. 4. At step S702, the computer 400 receives, through this screen, operations of selecting a content and a replaying device. If receiving an operation on the replay button 26 (see FIG. 4) at step S703, at steps S704 and S705 the computer 400 sends a URI of the content selected at step S702 and a replay instruction to the device selected at step S702.

On the other hand, if receiving an operation on the replay standby content addition button at step S703, at step S706 the computer 400 sends a URI of the content selected at step S702. The URI setting content selection process is thus finished.

Next, an example process of generating a content information database 1042 which is executed by the TV receiver 100 will be described with reference to a flowchart of FIG. 11.

First, when receiving a content URI setting instruction from a device connected via the network 200 at step S801, at step S802 the TV receiver 100 refers to a server information database 1041. At step S803, the TV receiver 100 searches for a server that is assigned an IP address corresponding to a URI that is contained in the received content URI setting instruction. The IP address corresponding to a URI module an IP address that coincides with a server IP address contained in the URI.

At step S804, the TV receiver 100 correlates the URI contained in the received content URI setting instruction with a UDN of the server having the IP address corresponding to the URI. If receiving a content replay instruction from the device connected via the network 200 (S805: YES), the TV receiver 100 sends a content transmission request such as “HTTP get” that is directed to a location indicated by the URI contained in the content URI setting instruction that was received at step S801.

When receiving the content that is transmitted from the server in response to the content transmission request, the TV receiver 100 replays (decodes) the received content at step S806. At step S807, the TV receiver 100 updates the content information database 1042 by changing the replay/non-replay information 36 of the replayed content to “replayed.” The content information database generation process is thus finished. If the TV receiver 100 does not receive a content replay instruction from the device connected via the network 200 (S805: NO), the content information database generation process is finished.

Next, an example process of replaying a replay standby content which is executed by the TV receiver 100 will be described with reference to a flowchart of FIG. 12.

When receiving a request for displaying a replay standby content selection screen at step S901, the TV receiver 100 refers to the server information database 1041 at step S902 and displays a replay standby content selection screen at step S903. When receiving an operation of selecting a replay content through the replay standby content selection screen at step S904, at step S905 the TV receiver 100 refers to the content information database 1042 and receives the UDN of a server that is stored with the selected content.

At step S906, the TV receiver 100 receives, from the server information database 1041, an IP address that is correlated with the UDN received at step S905. At step S907, the TV receiver 100 determines whether or not the IP address of the server that is stored with the content selected at step S904 is changed from the IP address that is held in the content information database 1042.

If an IP address change is found (S907: YES), at step S908 the TV receiver 100 updates the content information database 1042 using the new IP address. If no IP address change is found (S907: NO), the TV receiver 100 need not update the content information database 1042.

At step S909, the TV receiver 100 receives the content by sending a transmission request that is directed to a location indicated by the URI of the content selected at step S904 by referring to the content information database 1042. At step S910, the TV receiver 100 decodes (replays) the received content with the decoder 107 and displays a decoded content on the display unit 109. At step S911, the TV receiver 100 updates the content information database 1042, that is, changes the replay/non-replay information 36 of the replayed content to “replayed.”

In the processing of FIG. 12, after a replay content is selected, whether or not the address (URI) of the selected content has been changed. Alternatively, for example, when receiving server information, TV receiver 100 may determine whether or not a change has occurred in the addresses of the contents managed by the content information database 1042 based on a UDN and an IP address contained in the server information and may update a change-found address.

As described above, according to the embodiment, when receiving a URI of a replay subject content, the TV receiver 100 can receive and replay the content with arbitrary timing. Furthermore, the TV receiver 100 can receive the content more reliably from a server that is stored with the content.

The invention is not limited to the above embodiment itself and, in the practice stage, may be embodied in such a manner that constituent elements are modified without departing from the spirit and scope of the invention. For example, whereas in the embodiment a content URI and a UDN are held in the content information database 1042 so as to be correlated with each other for each content, the identifier to be correlated with a content URI is not limited to the UDN and may be any identifier that can be received from a server and enables its discrimination. And various inventions can be conceived by properly combining plural constituent elements disclosed in the embodiment. For example, several ones of the constituent elements of the embodiment may be omitted.

While certain embodiment has been described, the exemplary embodiment has been presented by way of example only, and is not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
an input module configured to receive an address of a content stored in a storage apparatus connected via a network;
a managing module configured to store the received address of the content and an identifier of the storage apparatus in such a manner that the address of the content and the identifier are correlated with each other;
a receiving module configured to receive the identifier and an address of the storage apparatus from the storage apparatus after the input module received the address of the content; and
an updating module configured to update the address of the content which is correlated with an identifier that coincides with the identifier received by the receiving module among identifiers managed by the managing module, based on the address of the storage apparatus received by the receiving module.

2. The apparatus of claim 1, further comprising:
a content receiving module configured to receive the content by sending a transmission request which specifies the address of the content managed by the managing module.

3. The apparatus of claim 1, further comprising:
a display device; and
a first display controller configured to cause the display device to display images for selecting the content of which the address are managed by the managing module.

4. The apparatus of claim 3, further comprising:
a receiving module configured to receive an operation on the images;
a decoding module configured to decode the content received by the content receiving module; and
a second display controller configured to cause the display device to display the decoded content,
wherein the content receiving module is configured to receive a content which corresponds to the image selected by the operation.

5. The apparatus of claim 4, wherein the first display controller is configured to cause the display device to display images for selecting contents that have not been decoded and images for selecting contents that have been decoded with such an arrangement that the images for selecting the non-decoded contents is given higher priority than the images for selecting the decoded contents.

6. The apparatus of claim 4, wherein the first display controller is configured to cause the display device to display pieces of information indicating whether the contents have been decoded by the decoding module together with the respective images for selecting the contents.

7. The apparatus according of claim 3, wherein the first display controller is configured to cause the display device to display pieces of information indicating times when the input module received the addresses of the contents, together with the respective images for selecting the contents.

8. The apparatus of claim 3, wherein the first display controller is configured to cause the display device to display the images for selecting the contents in such a manner that the addresses of the contents are arranged according to times when the input module received the respective addresses of the contents.

9. A content receiving method comprising:
receiving an address of a content stored in a storage apparatus connected via a network;
receiving an address of the storage apparatus from the storage apparatus after receiving the address of the content; and
receiving the content by sending a transmission request directed to an address that is different from the received address of the content based on the received address of the storage apparatus and the received address of the content if the received address of the storage apparatus is different from an address of the storage apparatus when the address of the content was received.
